(19) United States
(12) Patent Application Publication
(10) Pub. No.: US 2002/0039624 A1
(43) Pub. Date: Apr. 4, 2002

(54) Method and apparatus for forming barrier ribs for use in flat panel displays

(75) Inventor: Manabu Yabe, Kyoto (JP)

Correspondence Address: McDermott, Will & Emery, 600 13th Street, N.W., Washington, DC, 20005-3096, US

(73) Assignee: Dainippon Screen Mfg. Co., Ltd.

(21) Appl. No.: 09/969,732

(22) Filed: Oct. 4, 2001

(30) Foreign Application Priority Data
Oct. 4, 2000 (JP) 2000-304985(P)
Aug. 10, 2001 (JP) 2001-243598(P)

(51) Int. Cl. C08J 7/04; B05C 5/00; B05C 9/08; B05B 5/025

(52) U.S. Cl. 427/510; 118/620

(57) ABSTRACT

Barrier ribs are formed on a back plate moved while a rib material is delivered thereto from a nozzle. Immediately after the rib material is delivered from the nozzle to the back plate, the rib material is irradiated with light to promote curing of the rib material. By promoting curing of the rib material with light emitted immediately after delivery of the rib material, the rib material delivered linearly to the back plate is maintained in shape. The rib forming process is thereby simplified to form barrier ribs with high quality and high accuracy. The rib material is used efficiently to achieve low cost. Besides, the barrier ribs may be formed to have a high aspect ratio.

### BACKGROUND OF THE INVENTION

(1) Field of the Invention

This invention relates to flat panel displays such as plasma display panels built into computer display terminals, wall-mounted television receivers or the like. More particularly, the invention relates to a technique for forming barrier ribs.

(2) Description of the Related Art

Conventional barrier rib forming methods of the type noted above include, for example, “sand blast methods”, “screen printing”, “lift-off methods” and “mold process”. A “sand blast method” includes the steps of applying a rib material over an entire surface of a back plate, coating a sensitive film thereon, exposing and developing the film, carrying out a blast process, with a resist left in locations for forming barrier ribs, to remove unwanted parts of the rib material, removing the resist, and carrying out a baking process. A “lift-off method” includes the steps of applying a sensitive resist over an entire surface of a back plate, exposing and developing the sensitive resist to remove the resist only from locations for forming barrier ribs, filling recesses with a rib material, and removing the sensitive resist. The “mold process” includes the steps of applying a rib material over an entire surface of a back plate, and pressing a mold defining recesses against locations for forming barrier ribs.

The conventional methods with the above steps have the following drawbacks.

The “sand blast methods” and “lift-off methods”, which are the typical examples, have drawbacks of requiring a large number of steps, taking a long processing time, and involving a low material use efficiency. The “screen printing” has a drawback of low quality and low processing accuracy.

The “mold process” could damage the barrier ribs when removing the mold, and hence a drawback of low quality and low processing accuracy.

A method has been proposed to deliver a rib material from a nozzle to form barrier ribs. However, this method is unrealistic in that it is impossible to form barrier ribs with a high aspect ratio (i.e. a ratio of height to width).

Besides the above drawbacks, there are the following drawbacks as well. The rib material could undergo variations in viscosity as a result of ambient temperature changes or equipment temperature changes. With variations in the viscosity of the rib material, subtle variations occur with its delivery to vary the shape of barrier ribs formed on a back plate. That is, variations occur with the aspect ratio. Where, for example, the rib material includes an acrylic oligomer or an acrylic monomer with a viscosity in the order of 100,000 mPa/s (milli-Pascal per second) and ceramics powder (glass powder), a temperature change of 1° C. around room temperature (23° C.) causes a viscosity change of no less than 8,000 mPa/s, i.e. 8%. This viscosity change causes subtle variations in delivery of the rib material, resulting in variations in barrier rib profile.

### SUMMARY OF THE INVENTION

This invention has been made having regard to the state of the art noted above, and its object is to provide a method and apparatus for forming barrier ribs for use in flat panel displays at low cost and with a high aspect ratio, which is achieved by simplifying forming steps to improve material use efficiency while promoting quality and processing accuracy.

Another object of this invention is to provide a method and apparatus for forming barrier ribs for use in flat panel displays, with variations in barrier rib profile suppressed.

The above objects are fulfilled, according to this invention, by a method of forming barrier ribs on a back plate for use in a flat panel display, the method comprising:

a rib material delivery step for delivering a rib material from a nozzle while moving the nozzle and the back plate relative to each other; and

a rib material curing step for curing the rib material on the back plate while delivering the rib material from the nozzle.

According to the above method, the rib material delivery step is executed to deliver the rib material from the nozzle while moving the nozzle and the back plate relative to each other. The rib material curing step is executed to cure the rib material on the back plate while delivering the rib material from the nozzle. As a result, the rib material delivered to the back plate is maintained in shape thereon. This simplifies the process to form barrier ribs with high quality and high accuracy. Moreover, the rib material is used efficiently to achieve low cost. Since the rib material is cured while being delivered, barrier ribs may be formed to have a high aspect ratio.

Preferably, the rib material delivery step is executed for delivering the rib material simultaneously from a plurality of discharge openings formed in the nozzle. In this case, the rib material delivered in a plurality of flows is maintained in shape to form linear rows on the back plate.

Preferably, the rib material delivery step is executed for delivering the rib material from a plurality of nozzles arranged in a direction perpendicular to a direction of relative movement, with ends of the nozzles partly overlapping each other. The pitch of discharge openings of adjacent nozzles is made close to the pitch of discharge openings of a single nozzle. With the plurality of nozzles arranged in this way, barrier ribs may be formed over a large area at a time to reduce the number of forming steps.

Preferably, the rib material delivery step includes a rib material constant temperature delivery step for delivering the rib material from the nozzle while moving the nozzle and the back plate relative to each other, and while maintaining the rib material at a constant temperature. Thus, the rib material is delivered from the nozzle in a fixed state to reduce variations in the rib profile and stabilize the rib profile.

Preferably, the rib material constant temperature delivery step is executed for delivering the rib material from the nozzle, the rib material supplied being maintained at the constant temperature in or adjacent the nozzle. Then, the rib material is delivered from the nozzle in the fixed state to achieve stability of the shape and size of the barrier ribs efficiently by a small amount energy.

Preferably, the rib material constant temperature delivery step is executed for delivering the rib material from the nozzle, the rib material supplied being maintained at the constant temperature in or adjacent the nozzle, lower than a temperature upstream thereof. With this method, the rib material may be transported in a low viscosity condition to the nozzle or to the vicinity of the nozzle. The viscosity of the rib material may thereby be increased in or adjacent the nozzle. This facilitates transportation of the rib material.

In another aspect of this invention, a method of forming barrier ribs on a back plate for use in a flat panel display is provided, which comprises:

a lift-off resist delivery step for delivering a lift-off resist from a nozzle to form relief patterns while moving the nozzle and the back plate relative to each other;

a lift-off resist curing step for curing the lift-off resist;

a filling step for filling a rib material into spaces between the relief patterns;

a rib material curing step for curing the rib material; and

a removal step for removing the relief patterns;

the above steps being successively executed to form barrier ribs.

According to the above method, the lift-off resist delivery step is first executed to deliver the lift-off resist from the nozzle to form relief patterns while moving the nozzle and the back plate relative to each other. After the lift-off resist curing step for curing the lift-off resist, the filling step is executed to fill the rib material into the spaces between the relief patterns. After the rib material curing step for curing the rib material, the removal step is executed to remove the relief patterns, thereby forming barrier ribs on the back plate. The lift-off resist for forming the relief patterns has low viscosity since it does not include glass as does the rib material. Thus, the lift-off resist may be delivered under reduced pressure, and the discharge openings of the nozzle may have an appropriate shape. Consequently, the relief patterns may be formed with high quality and high accuracy, without complicating the process. The barrier ribs may also be formed in a similar shape. Moreover, the rib material is used efficiently to achieve low cost. Since the relief patterns are formed with high accuracy, the barrier ribs may be formed to have a high aspect ratio.

Preferably, the lift-off resist delivery step is executed for curing the lift-off resist while being delivered. Thus, the relief patterns are formed with high accuracy.

Preferably, the lift-off resist delivery step is executed for delivering the lift-off resist simultaneously from a plurality of discharge openings formed in the nozzle. In this case, the lift-off resist delivered in a plurality of flows is maintained in shape to form linear rows on the back plate.

Preferably, the lift-off resist delivery step is executed for delivering the lift-off resist from a plurality of nozzles arranged in a direction perpendicular to a direction of relative movement, with ends of the nozzles partly overlapping each other. Thus, the pitch of discharge openings of adjacent nozzles is made close to the pitch of discharge openings of a single nozzle.

Preferably, the lift-off resist delivery step includes a lift-off resist constant temperature delivery step for delivering the lift-off resist from the nozzle while moving the nozzle and the back plate relative to each other, and while maintaining the lift-off resist at a constant temperature. Thus, the lift-off resist is delivered from the nozzle in a fixed state to stabilize the shape and size of the relief patterns. The rib material is thereafter filled into the spaces between the relief patterns. After curing the rib material, the relief patterns are removed, thereby forming barrier ribs of steady shape and size on the back plate.

In a further aspect of the invention, an apparatus for forming barrier ribs on a back plate for use in a flat panel display is provided, which apparatus comprises:

a nozzle for delivering a rib material;

a support table for supporting the back plate;

a moving device for moving the nozzle and the support table relative to each other; and

a curing device for curing the rib material delivered to the back plate;

wherein the rib material is delivered from the nozzle while the moving device is operated to move the nozzle and the back plate relative to each other, and the rib material on the back plate is cured by the curing device while the rib material is delivered from the nozzle.

With the above apparatus, the curing device cures the rib material while the moving device is operated to move the nozzle and the back plate relative to each other, and while delivering the rib material from the nozzle. As a result, the rib material delivered to the back plate is maintained in shape. This simplifies the process to form barrier ribs with high quality and high accuracy. Moreover, the rib material is used efficiently to achieve low cost. Since the rib material is cured while being delivered, barrier ribs may be formed to have a high aspect ratio.

In a different aspect of this invention, an apparatus for forming barrier ribs on a back plate for use in a flat panel display is provided, which comprises:

a nozzle for delivering a lift-off resist to form rib-forming relief patterns;

a support table for supporting the back plate;

a moving device for moving the nozzle and the support table relative to each other;

a curing device for curing the lift-off resist delivered to the back plate;

a filling device for filling a rib material into spaces between the relief patterns; and

a removing device for removing the relief patterns;

wherein the lift-off resist is delivered from the nozzle while the moving device is operated to move the nozzle and the back plate relative to each other.

With the above apparatus, the lift-off resist is delivered from the nozzle to form relief patterns while the moving device is operated to move the nozzle and the back plate relative to each other. Subsequently, the filling device is operated to fill the rib material into the spaces between the relief patterns. After the rib material is cured, the removing device is operated remove the relief patters, thereby forming barrier ribs on the back plate. Thus, the relief patterns may be formed with high quality and high accuracy, without complicating the process. The barrier ribs may also be formed in a similar shape. Moreover, the rib material is used efficiently to achieve low cost. Since the relief patterns are formed with high accuracy, the barrier ribs may be formed to have a high aspect ratio.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a side view schematically showing an outline of an apparatus for forming barrier ribs for use in flat panel displays in a first embodiment of this invention;

FIG. 2 is a bottom view of a nozzle;

FIG. 3 is a schematic view showing a barrier rib forming process;

FIG. 4 is a view showing a preferred arrangement of a plurality of nozzles;

FIG. 5A is a view showing a modification of discharge openings;

FIG. 5B is a view showing another modification of discharge openings;

FIG. 6 is a side view schematically showing an outline of an apparatus for forming barrier ribs for use in flat panel displays in a second embodiment of this invention;

FIG. 7 is a bottom view of a nozzle;

FIG. 8 is a schematic view showing a barrier rib forming process, and particularly a relief pattern forming step;

FIG. 9 is a schematic view showing the barrier rib forming process, and particularly a rib material filling step;

FIG. 10 is a schematic view showing the barrier rib forming process, and particularly with relief patterns removed;

FIG. 11 is a side view schematically showing an outline of an apparatus for forming barrier ribs for use in flat panel displays in a third embodiment of this invention;

FIG. 12 is a view in vertical section showing an outline of a nozzle and adjacent components in the third embodiment;

FIG. 13 is a side view schematically showing a tilted nozzle of the apparatus for forming barrier ribs for use in flat panel displays in each embodiment; and

FIG. 14 is a side view schematically showing an outline of an apparatus for forming barrier ribs for use in flat panel displays in a further embodiment of this invention;

### DESCRIPTION OF THE PREFERRED EMBODIMENTS

Preferred embodiments of this invention will be described in detail hereinafter with reference to the drawings.

<First Embodiment>

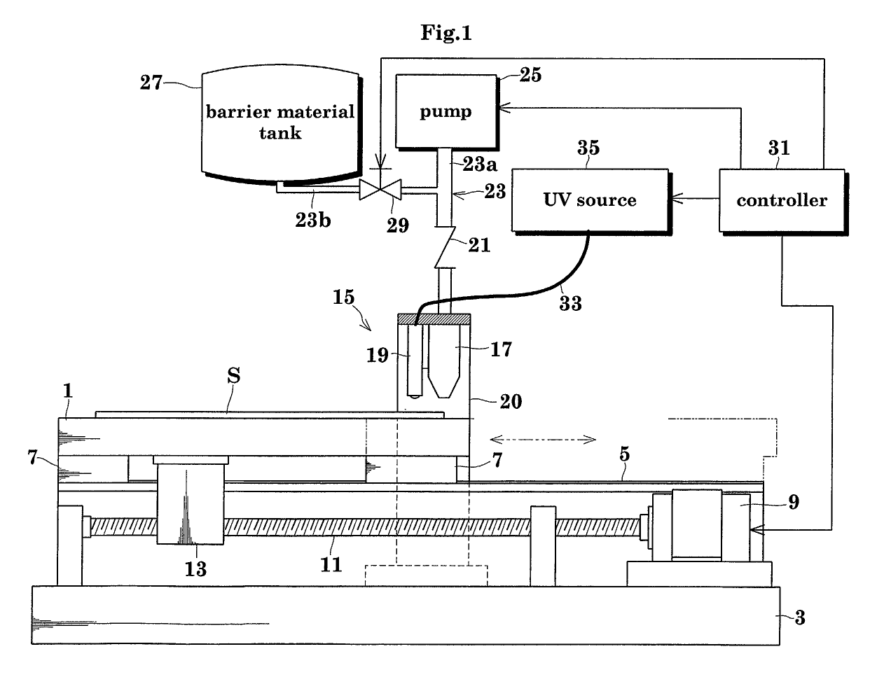

FIG. 1 is a view schematically showing an outline of an apparatus for forming barrier ribs for use in flat panel displays according to this invention.

A back plate S for a flat panel display is, for example, a glass substrate which is placed on a support table 1. A guide rail 5 is disposed on a base 3, and slide members 7 attached to a lower surface of the support table 1 are slidably fitted on the guide rail 5. With these components, the support table 1 is movable right and left in FIG. 1.

A motor 9 is mounted on an upper surface of the base 3, with a rotary shaft extending horizontally. A screw shaft 11 is connected to the rotary shaft of motor 9, and a connecting piece 13 attached to the lower surface of support table 1 is meshed with the screw shaft 11. Thus, by operating the motor 9, the support table 1 is moved right and left. The motor 9 corresponds to the moving device of this invention.

A delivery unit 15 for delivering a rib forming material is disposed adjacent a right-hand end of the support table 1 and adjacent the center of the base 3. The delivery unit 15 includes a nozzle 17 and a light emitter 19, and is attached to a frame 20 to straddle the support table 1. In this embodiment, the rib material is delivered from the nozzle 17 when the support table 1 moves leftward relative thereto. The light emitter 19 is disposed to the left of the nozzle 17, corresponding to the rear of the nozzle 17 with respect to the movement of support table 1, in order to irradiate the rib material delivered to promote curing thereof.

The above light emitter 19 corresponds to the curing device of this invention.

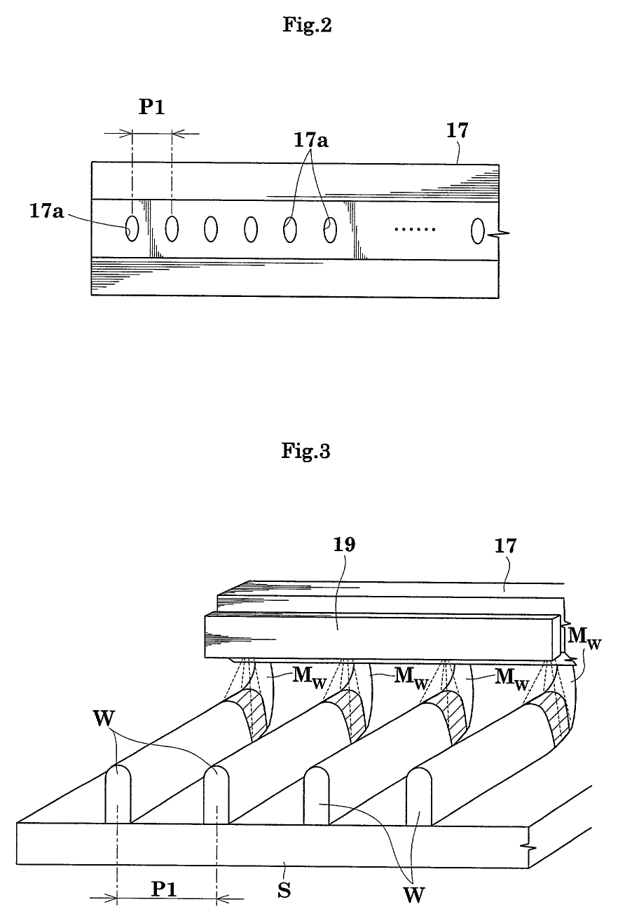

Reference is now made to FIG. 2 showing the nozzle 17 as seen from below.

This nozzle 17 defines a plurality of discharge openings 17a arranged in a row in a direction normal to the plane of FIG. 1 and sideways in FIG. 2. Each discharge opening 17a in this embodiment is shaped elliptic with a major axis extending in the moving direction of the support table 1. Each discharge opening 17a has a diameter in the order of 30 82 m. The discharge openings 17a are arranged at a pitch P1 of approximately 150 μm. The discharge openings 17a may be given any shape according to a desired shape in vertical section of the barrier ribs.

The nozzle 17 is connected to a supply pipe 23 with a check valve 21 mounted thereon. The supply pipe 23 has an upper pipe 23a connected to a pump 25, and a branch pipe 23b extending from the upper pipe 23a upstream of the check valve 21 to a rib material tank 27. The branch pipe 23b has a switch valve 29 mounted thereon.

The above motor 9, pump 25 and switch valve 29 are controlled by a controller 31 including a CPU not shown. The controller 31 operates the motor 9 to move the support table 1 leftward in FIG. 1, thereby moving the back plate S leftward relative to the nozzle 17. At this time, the controller 31 controls the pump 25 and switch valve 29 to deliver the rib material from the nozzle 17.

Specifically, the pump 25 is first operated to take sucking action, with the switch valve 29 opened, to draw the rib material into the upper pipe 23a. At this time, the check valve 21 prevents a rib material remaining in the nozzle 17 from being drawn back. Next, the pump 25 is operated to take discharging action, with the switch valve 29 closed, to discharge the rib material from the upper pipe 23a out through the check valve 21, thereby supplying the rib material to the nozzle 17. By repeating a series of these operations, the rib material is delivered from the discharge openings 17a of the nozzle 17.

A mechanism of delivering the rib material to the back plate S will be described now. First, the rib material is extruded from the tip of nozzle 17. The tip of nozzle 17 is placed in contact with or adjacent (with a spacing of several tens of μm) the back plate S, so that forward or lower ends of the rib material extruded may promptly reach the back plate S. Thus, the lower ends of the rib material (i.e. the width of the lower ends of barrier ribs) have a value close to the nozzle openings. However, depending on the property of the rib material, wettability of the rib material at the tip of nozzle 17 and the rate of extrusion, the value may be slightly larger (when the nozzle 17 tends to be wet) or smaller (when the nozzle 17 tends to be dry to cause contracted veins) than the nozzle openings. In a comparison between relative velocity of the nozzle 17 and back plate S and extruding rate of the rib material, the flows will widen in a situation like a pressing texture, and narrow in a situation like a pulling texture. Further, the flows are influenced also by wettability with the back plate S. Since wettability is relatively good, the flows tend somewhat to spread after contacting the back plate S until curing. Actually, and generally, however, the flows form rib bottoms with a width of nozzle openings (e.g. 60 μm)+several μm, and barrier ribs with a width approximately corresponding that of the nozzle openings (approx. 60 μm).

The light emitter 19 receives ultraviolet light from an ultraviolet source 35 connected thereto through an optical fiber 33 to promote curing of the rib material. While ultraviolet light is used in this embodiment, the type of light is not limited to ultraviolet light as long as the light can promote curing of the rib material. The rib material has a somewhat low viscosity to facilitate delivery from the nozzle 17, and has a UV curable resin mixed with a binder.

Apart from the use of ultraviolet light, the curing device may be adapted to cure the rib material by applying heat thereto (e.g. emitting heat or supplying a hot blast).

A rib forming operation by the above apparatus will be described next with reference to FIG. 3. FIG. 3 is a schematic view showing a rib forming process.

First, a back plate S is placed on the support table 1, and fixed thereto by suction, for example.

Next, while rotating the motor 9 at fixed speed, the pump 25 and switch valve 29 are controlled to deliver rib material M_{R} from the nozzle 17 as noted hereinbefore. Then, since the support table 1 moves at fixed speed leftward, the rib material M_{W} delivered in a plurality of flows from the nozzle 17 deposits to form linear walls on the upper surface of back plate S. In this way, a rib material delivery step is provided to deliver the rib material M_{W} from the nozzle 17 while moving the nozzle 17 and back plate S relative to each other. In addition, as shown in dotted lines in FIG. 3, ultraviolet light is emitted from the light emitter 19 immediately after the delivery from the nozzle 17 to promote curing. Consequently, barrier ribs W are formed at the pitch P1 of arrangement of discharge openings 17a with hardly any sagging of the rib material M_{W}. In this way, a rib material curing step is provided to cure the rib material M_{W} on the back plate S while delivering the rib material M_{W} from the nozzle 17.

The time taken from immediately after the delivery of the rib material M_{W} to the curing thereof by the light emitter 19 is at most one second in this first embodiment, though it is variable with the scan speed of the nozzle 17 and the curing device such as the light emitter 19.

Finally, the product is baked at a temperature of 500 to 600° C. to complete barrier ribs for a flat panel display.

As noted above, the rib material M_{W}, while being delivered, is irradiated with ultraviolet light to be cured. That is, immediately after the delivery, the rib material M_{W} is irradiated with ultraviolet light to promote its curing. The rib material M_{W} is thereby maintained in shape on the back plate S. This simplifies the process to form barrier ribs W with high quality and high accuracy. Moreover, the rib material M_{W} is used efficiently to achieve low cost. Since the rib material M_{W} is cured immediately after delivery, the barrier ribs W may be formed to have a high aspect ratio.

Where the back plate S has such a large area that barrier ribs W cannot be formed over a desired area at a time, the support table 1 may be returned to an initial position to carry out the above process again after feeding the nozzle 17 in Y-direction with a feed mechanism not shown. Rather than returning the support table 1, two light emitters 19 may be arranged in opposite positions across the nozzle 17 to allow the rib material to be delivered during both forward and backward movements of the support table 1.

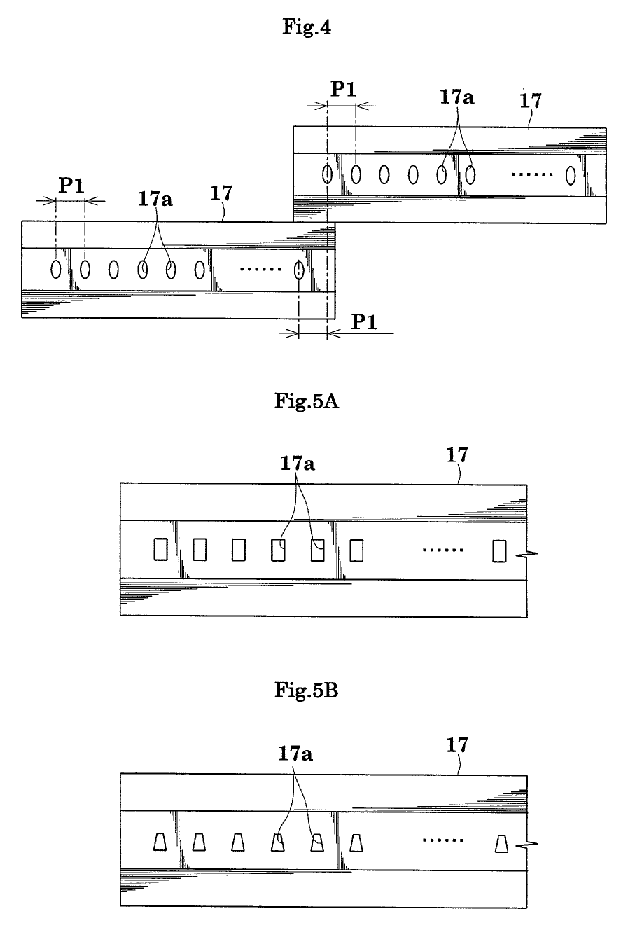

A plurality of nozzles 17 may be arranged in a row. If, however, the plurality of nozzles 17 were simply aligned, the pitch P1 of arrangement of discharge openings 17a that determines the pitch of barrier ribs W would be increased by the thickness of end walls of the nozzles 17, to disrupt the pitch of barrier ribs W. It is thus preferable that, as shown in FIG. 4, the nozzles 17 are arranged with adjacent ends thereof partly overlapping each other so that the discharge openings 17a of adjacent nozzles 17 are arranged at the pitch P1. With the plurality of nozzles 17 arranged in this way, barrier ribs may be formed over a large area at a time to reduce the number of forming steps.

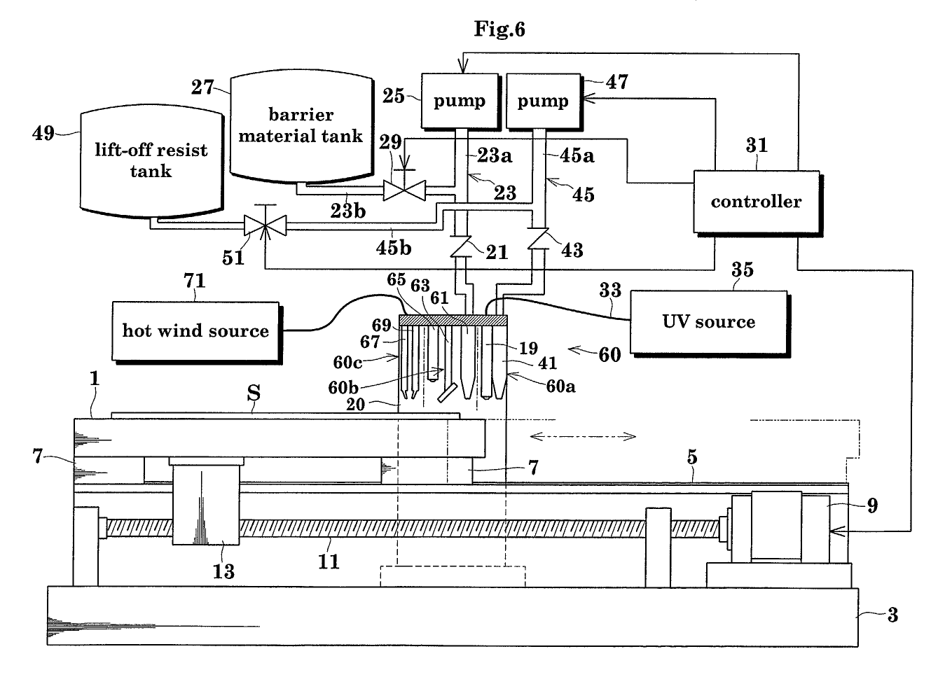

The discharge openings 17a of the nozzle 17 are not limited to the elliptic shape noted hereinbefore. That is, the shape may be oval, or rectangular as shown in FIG. 5A, or trapezoidal as shown in FIG. 5B. By devising the shape of discharge openings 17a as above, the barrier ribs may be prevented from collapsing due to sagging of the rib material which may occur to a certain extent despite the promotion of curing. Particularly, the discharge openings 17a are longer in the direction of movement relative to the back plate S than in the direction perpendicular to the direction of relative movement. This arrangement facilitates an increase in the height of barrier ribs to achieve a high aspect ratio thereof. That is, the rib material is delivered to the back plate S in a way to form high barrier ribs having a high aspect ratio.

Where the back plate S has “waves”, the spacing between support table 1 and nozzle 17 may be maintained constant by using a distance measuring device for measuring a distance between the upper surface of back plate S and the nozzle 17, and a lift device for varying a vertical relationship between the nozzle 17 and support table 1. This measure will stabilize the height of barrier ribs W.

<Second Embodiment>

A second embodiment will be described with reference to FIG. 6.

In the first embodiment described above, barrier ribs W are formed directly. In this embodiment, relief patterns are first formed, and then the rib material is filled into spaces between the patterns to form barrier ribs. Like references are used to identify like parts which are the same as in the first embodiment and will not be described again.

In the second embodiment, three processing units 60 are provided. The processing units 60 include a delivery unit 60a, a filling unit 60b and a removal unit 60c.

The delivery unit 60a has a nozzle 41 and a light emitter 19 attached thereto. The nozzle 41 is connected to a supply pipe 45 with a check valve 43 mounted thereon. The supply pipe 45 has an upper pipe 45a connected to a pump 47. A branch pipe 45b extending from the upper pipe 45a upstream of the check valve 43 is connected to a lift-off resist tank 45. The branch pipe 45b has a switch valve 51 mounted thereon.

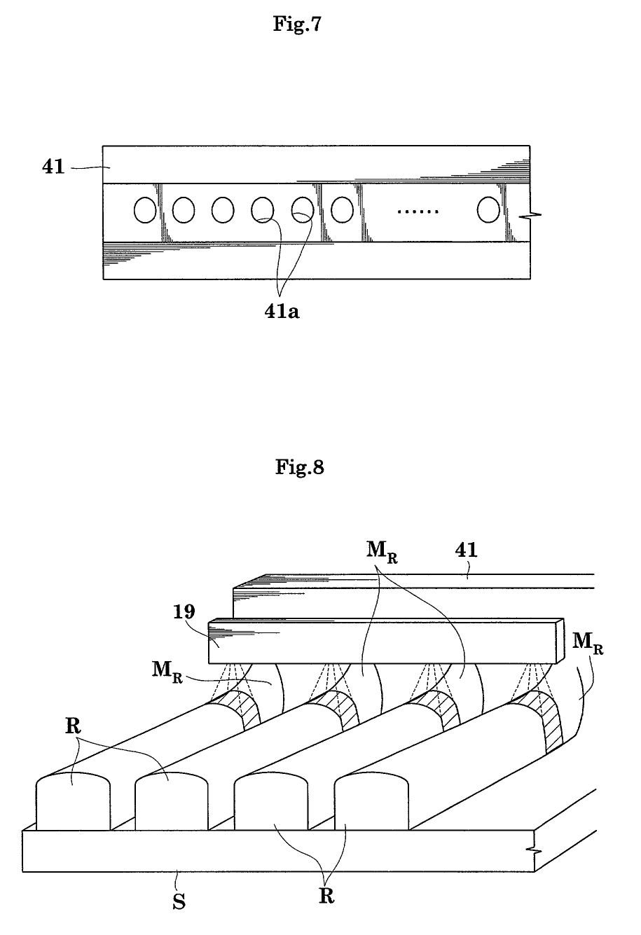

As shown in FIG. 7, the nozzle 41 defines a plurality of discharge openings 41a. The discharge openings 41a may have a varied shape.

The nozzle 41 corresponds to the nozzle device for delivering a lift-off resist in this invention.

A lift-off resist tank 49 stores a lift-off resist with a binder containing an ultraviolet curable resin. This lift-off resist has low viscosity since it does not include glass powder as does the rib material.

The filling unit 60b includes a slit nozzle 61, a blade 63 and an infrared heater 65. As distinct from the nozzle 41, the slit nozzle 61 defines a discharge opening in the form of a slit for delivering the material from the rib material tank 27 linearly and vertically to the direction of movement of the back plate S. The blade 63 removes only those parts of the rib material present outside the spaces between the relief patterns formed of the lift-off resist. The infrared heater 65 provisionally bakes the rib material.

The slit nozzle 61 and blade 63 correspond to the filling device of this invention.

The removal unit 60c includes a hot air-knife 67 and an aspirator 69. The hot air-knife 67 blows hot wind, under high pressure, from a hot wind source 71 against the lift-off resist or relief patterns, thereby melting and blowing off the lift-off resist. The aspirator 69 sucks the lift-off resist blown off, and discharges it in a predetermined location.

The hot air-knife 67 corresponds to the removing device of this invention.

A rib forming operation by the above apparatus will be described next with reference to FIGS. 8 through 10. FIGS. 8 through 10 are schematic views showing a rib forming process.

First, a back plate S is placed on and fixed to the support table 1.

Next, while rotating the motor 9 at fixed speed, the pump 47 and switch valve 51 are controlled to deliver the lift-off resist from the nozzle 41 of the delivery unit 60a. Then, since the support table 1 moves at fixed speed leftward, the lift-off resist M_{R} delivered in a plurality of flows from the nozzle 41 deposits on the upper surface of back plate S. In this way, a lift-off resist delivery step is provided to deliver the lift-off resist M_{R} from the nozzle 41 while moving the nozzle 41 and back plate S relative to each other. At this time, as shown in dotted lines in FIG. 8, ultraviolet light is emitted from the light emitter 19 immediately after the delivery from the nozzle 41 to promote curing. Consequently, relief patterns R are formed with hardly any sagging of the lift-off resist M_{R}. In this way, a lift-off resist curing step is provided to cure the lift-off resist M_{R} on the back plate S while delivering the lift-off resist M_{R} from the nozzle 41.

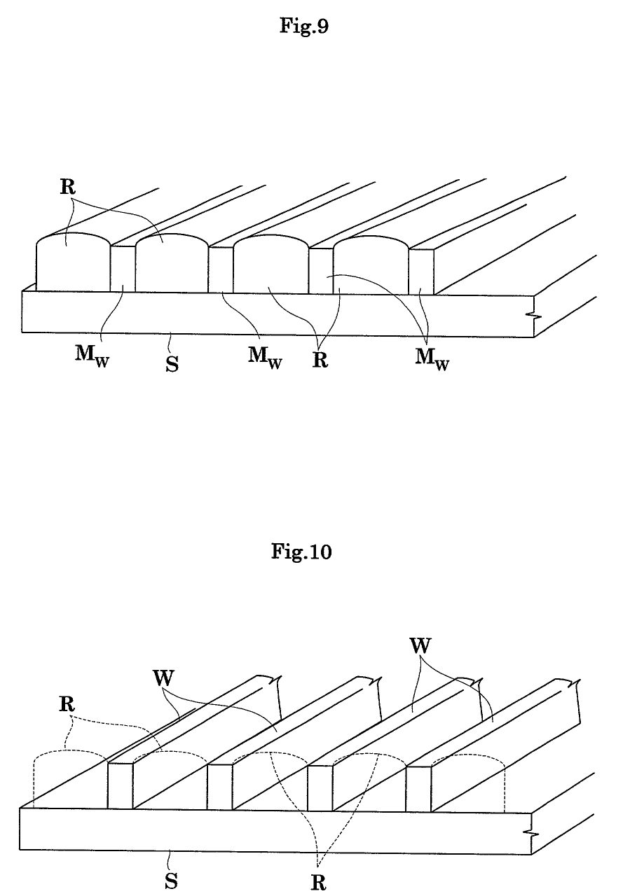

Next, the support table 1 is returned to the original position, and then the filling unit 60b is used to supply the rib material M_{W} (see FIG. 9). Specifically, while rotating the motor 9 at fixed speed, the pump 25 and switch valve 29 are controlled to deliver the rib material M_{W} from the slit nozzle 61. At this time, the rib material M_{W} is delivered all over according to the width of slit nozzle 61. Unwanted part of the rib material M_{W} is removed or driven into the spaces between the relief patterns R by the blade 63. As shown in FIG. 9, the rib material M_{W} is filled only into the spaces between the patterns R. Since the patterns R have some elasticity, the barrier ribs resulting from the leveling action of the blade 63 have substantially flat tops at a slightly lower level than the tops of the patterns R as seen in FIG. 9. Thus, a filling step is carried out for filling the rib material M_{W} in the spaces between the patterns R. The rib material M_{W} is provisionally baked by the heat from the infrared heater 65. In this way, a rib material curing step is carried out to cure the rib material M_{W}.

Next, the support table 1 is returned to the original position, and then the removal unit 60b is used to remove the lift-off resist M_{R} (see FIG. 10). Specifically, while rotating the motor 9 at fixed speed, the hot air-knife 67 and aspirator 69 are operated to melt and blow off the lift-off resist M_{R} forming the patterns R, thereby discharges the lift-off resist M_{R} out of the apparatus. At this time, the rib material M_{W} having been baked provisionally will never be blown off by the hot air-knife 67. In this way, a removing step is carried out to remove the lift-off resist M_{R}.

Finally, the rib material M_{W} is baked at 500 to 600° C. to complete barrier ribs W.

As described above, barrier ribs W are formed by forming the patterns R once, then filling the rib material M_{W} into the spaces between the patterns R, provisionally baking the rib material M_{W}, and thereafter removing the patterns R. The lift-off resist M_{R} for forming the patterns R has low viscosity since it does not include glass powder as does the rib material M_{W}. Thus, the lift-off resist M_{R} may be delivered at reduced pressure, and the discharge openings of the nozzle 41 may have an appropriate shape. Consequently, the patterns R may be formed with high quality and high accuracy, without complicating the process. The barrier ribs W may also be formed in a similar shape. Moreover, the rib material M_{W} is used efficiently to achieve low cost. Since the relief patterns are formed with high accuracy, the barrier ribs W may be formed to have a high aspect ratio.

In the second embodiment, light is used to cure the lift-off resist. However, the lift-off resist may be cured by emitting heat or supplying a hot blast. Further, in this embodiment, the lift-off resist is cured immediately after delivery. It is not absolutely necessarily to perform a curing process immediately after delivery. For example, after the resist is delivered, a curing process may be performed by a separate curing device.

Further, where a plurality of nozzles 41 are arranged as in the first embodiment, as shown in FIG. 4, it is preferable that adjacent ends of the nozzles 41 partly overlap each other.

In the above embodiment, the delivery unit 60a, filling unit 60b and removal unit 60c are operated separately, and the back plate S is moved three times. Instead, these units may be operated simultaneously, with the back plate S moved only once. That is, barrier ribs may be formed by locally forming relief patterns, filling the rib material, provisionally baking the rib material and removing the relief patterns, with the back plate S moved continuously. This mode will, of course, reduce the process time.

The delivery unit 60a, filling unit 60b and removal unit 60c may be incorporated into three separate apparatus, respectively. Thus, the rib forming process is carried out by using the three apparatus.

The discharge openings 41a of the nozzle 41 are shaped longer in the direction of relative movement between the nozzle 41 and the back plate S than in the direction perpendicular to the direction of relative movement. This arrangement facilitates an increase in the height of relief patterns. Barrier ribs are formed by filling the rib material between the high relief patterns, curing the rib material, and removing the relief patterns. Thus, the barrier ribs are formed with facility to have a high aspect ratio.

<Third Embodiment>

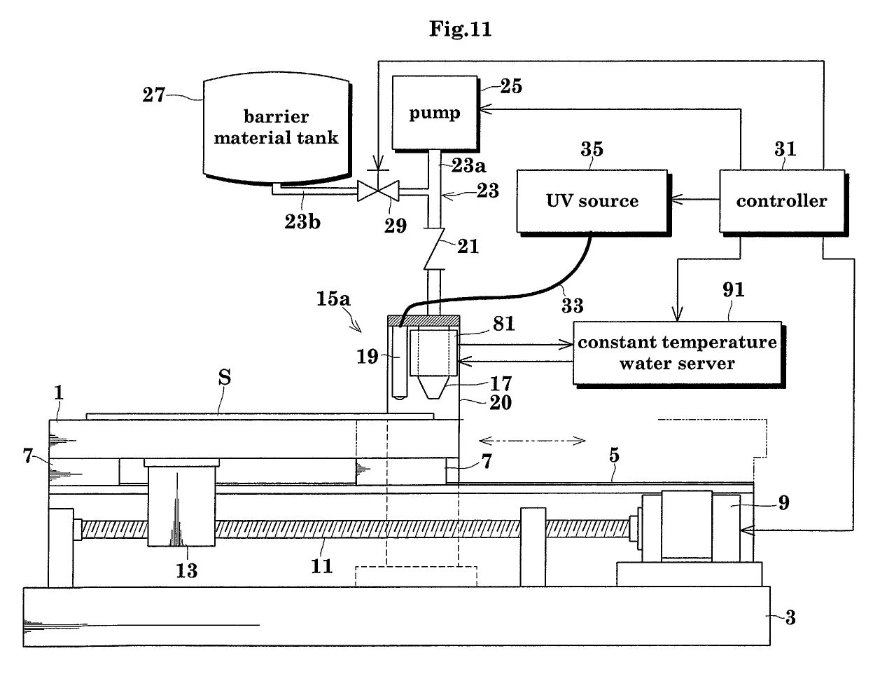

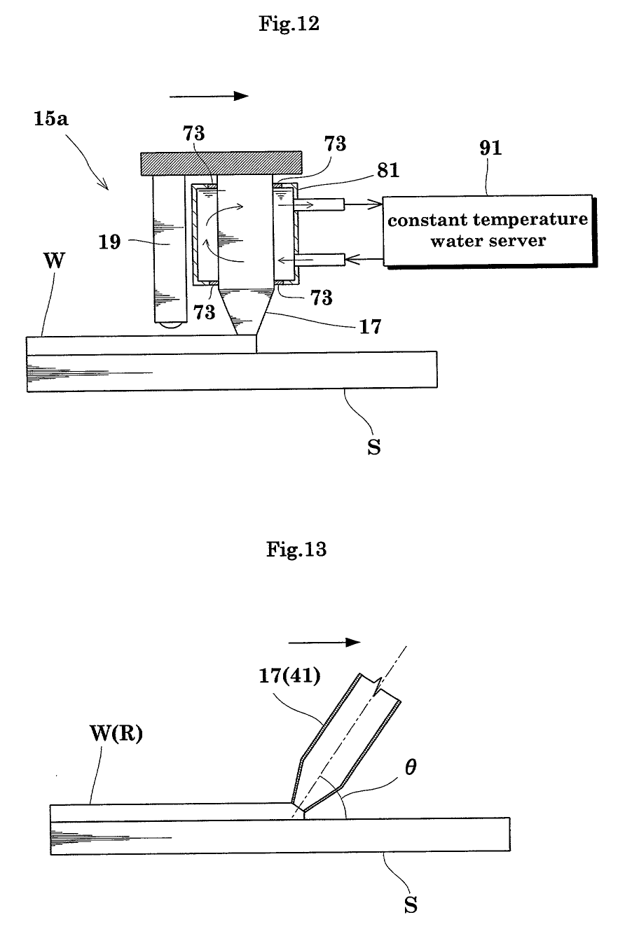

A third embodiment will be described with reference to FIGS. 11 and 12. FIG. 11 is a side view schematically showing an outline of an apparatus for forming barrier ribs for use in flat panel displays in the third embodiment. FIG. 12 is a view in vertical section showing an outline of a nozzle and adjacent components shown in FIG. 11.

In the first embodiment described hereinbefore, barrier ribs W are formed directly by delivering the rib material to the back plate S without adjusting the temperature of nozzle 17. In this embodiment, barrier ribs W are formed by delivering from the nozzle 17 the rib material maintained at a constant temperature. That is, the rib material delivery step in the foregoing first embodiment, here, includes a rib material constant temperature delivery step for delivering the rib material from the nozzle 17 while moving the nozzle 17 and back plate S relative to each other, and while maintaining the rib material at a constant temperature. Like references are used to identify like parts which are the same as in the first embodiment and will not be described again.

The third embodiment provides a delivery unit 15a. The delivery unit 15a includes a nozzle 17 and a light emitter 19 as in the foregoing first embodiment, and further includes a cooling jacket 81 surrounding the nozzle 17. The cooling jacket 81 is connected to a constant temperature water server 91 for supplying the cooling jacket 81 with constant temperature water.

The constant temperature water server 91 is capable of supplying the cooling jacket 81 with constant temperature water maintained at a desired temperature within a predetermined temperature range (e.g. 0° C. to room temperature: 23° C.). It is assumed that, in the third embodiment, the cooling jacket 81 is supplied with constant temperature water at a lower temperature (e.g. 15° C.) than the temperature of a room where the subject apparatus is installed (e.g. 23° C.). Further, the third embodiment will be described, assuming that the rib material includes an acrylic oligomer or an acrylic monomer with a viscosity in the order of 100,000 mPa/s (milli-Pascal per second) and ceramics powder (glass powder).

As shown in FIG. 12, the cooling jacket 81 is a hollow container mounted to cover the outer circumference of nozzle 17. Constant temperature water is supplied from the constant temperature water server 91 to the hollow portion of the cooling jacket 81. The constant temperature water supplied contacts the outer circumference of the nozzle 17 to maintain the nozzle 17 itself at the constant temperature, thereby to maintain the rib material in the nozzle 17 at the constant temperature. The constant temperature water outputted from the constant temperature water server 91 is inputted to an input port of the cooling jacket 81. The constant temperature water in the cooling jacket 81 is drained from an output port of the cooling jacket 81. The interior of the cooling jacket 81 is filled with the constant temperature water in a predetermined quantity circulating therethrough. Piping for connecting the cooling jacket 81 and constant temperature water server 91 has a double pipe construction with temperature retaining property to avoid temperature change of the constant temperature water being supplied from the constant temperature water server 91 to the cooling jacket 81.

Seals 73 are disposed between the nozzle 17 and cooling jacket 81 to prevent the constant temperature water in the cooling jacket 81 from leaking out from between the nozzle 17 and cooling jacket 81. The nozzle 17 and cooling jacket 81 may be manufactured as an integral unit to dispense with the seals 73.

The cooling jacket 81 and constant temperature water server 91 correspond to the thermostat device of this invention.

A rib forming operation by the above apparatus will be described next with reference to FIG. 11.

First, a back plate S is placed on the support table 1, and fixed thereto by suction, for example.

The constant temperature water server 91 starts a circulating supply of constant temperature water at the predetermined temperature (e.g. 15° C.) to the cooling jacket 81. The temperature of the room where the apparatus in this embodiment is installed is set to 23° C., for example. The outer circumference of the nozzle 17 becomes a fixed temperature (e.g. 15° C.) through contact with the constant temperature water in the cooling jacket 81. The rib material in the nozzle 17 also is maintained at the fixed temperature (e.g. 15° C.). Since the room temperature is 23° C., the viscosity of the rib material moving from the rib material tank 27 to the nozzle 17 is approximately 100,000 mPa/s (milli-Pascal per second). The viscosity of the rib material in the nozzle 17, which is maintained at the fixed temperature (e.g. 15° C.), increases to a high level, i.e. 100,000+8,000×8° C.=164,000 mPa/s (milli-Pascal per second).

Next, while rotating the motor 9 at fixed speed, the pump 25 and switch valve 29 are controlled, as in the first embodiment, to deliver the rib material at the constant temperature from the nozzle 17. A small quantity of rib material consumed in forming minute barrier ribs is easily cooled in the thin nozzle 17 in a short time, and delivered while being maintained at the fixed temperature (e.g. 15° C.). Then, since the support table 1 moves at fixed speed leftward, the rib material M_{W} delivered in a plurality of flows from the nozzle 17 deposits to form linear walls on the upper surface of back plate S. Moreover, the rib material is delivered as maintained at the fixed temperature (e.g. 15° C.), i.e. as maintained at a fixed viscosity (e.g. 100,000+8,000×8° C.=164,000 mPa/s (milli-Pascal per second)). Thus, the rib material is delivered from the nozzle 17 in a fixed state to reduce variations in the rib profile and stabilize the rib profile.

Further, ultraviolet light is emitted from the light emitter 19 immediately after the delivery from the nozzle 17 to promote curing. Consequently, barrier ribs W are formed at the pitch P1 of arrangement of discharge openings 17a with a still less chance of sagging of the rib material M_{W} than in the first embodiment. The time taken from immediately after the delivery of the rib material to the curing thereof by the light emitter 19 is at most one second in this third embodiment, though it is variable with the scan speed of the nozzle 17 and the curing device such as the light emitter 19. Finally, the product is baked at a temperature of 500 to 600° C. to complete barrier ribs for a flat panel display.

As noted above, the rib material is delivered from the nozzle 17 as maintained at the fixed temperature. Particularly, in forming barrier ribs required to have a high aspect ratio, the rib material not cured yet after the delivery is deformed to a fixed extent by surface tension and gravity within a time elapsed until curing of the rib material. The fixed state of rib material delivery from the nozzle 17 stabilizes the shape and size of the barrier ribs.

Since the rib material supplied is maintained at the constant temperature in the nozzle 17, the rib material is delivered from the nozzle 17 in the fixed state to achieve stability of the shape and size of the barrier ribs efficiently by a small amount energy. In the third embodiment, the rib material supplied is maintained at the constant temperature in the nozzle 17. The same effect will be produced by maintaining the rib material at the constant temperature in the vicinity of the nozzle 17, instead.

The rib material supplied is delivered as maintained at the constant temperature in or adjacent the nozzle 17, which is lower than the temperature upstream of the nozzle 17. Thus, the rib material may be transported in a low viscosity condition to the nozzle 17 or to the vicinity of the nozzle 17. The viscosity of the rib material may be increased only in or adjacent the nozzle 17. This facilitates transportation of the rib material. There is no need to provide a pressure resistant design for the rib material supply system, or to use a pump of increased pressure.

The viscosity of the rib material may be increased in time of delivery by lowering the temperature of the rib material in or adjacent the nozzle 17 below room temperature. This achieves a high aspect ratio required of the barrier ribs with ease. Since the rib material in or adjacent the nozzle 17 is maintained at the low temperature, the increase in the viscosity of the rib material in the nozzle 17 does not cause a great increase in resistance to the delivery. Rib materials of lower viscosity may be included in a range for selection. A rib material which becomes highly viscous (e.g. several hundred thousand mPa/s) near room temperature is difficult to manufacture by increasing the degree of polymerization of a resin used in the rib material. According to this invention, however, a rib material having a high viscosity in the order of 1,000,000 mPa/s may be produced with ease.

This invention may be modified as follows:

<Modifications>

(1) In the first to third embodiments described above, the support table 1 with the back plate S placed thereon is constructed movable. Instead, the support table 1 may be fixed, with the delivery unit 15, processing unit 60 or delivery unit 15a adapted movable.

(2) In the third embodiment, the water-cooling constant temperature water server 91 is employed as the thermostat device. This device may, for example, use an air-cooling system or Peltier effect.

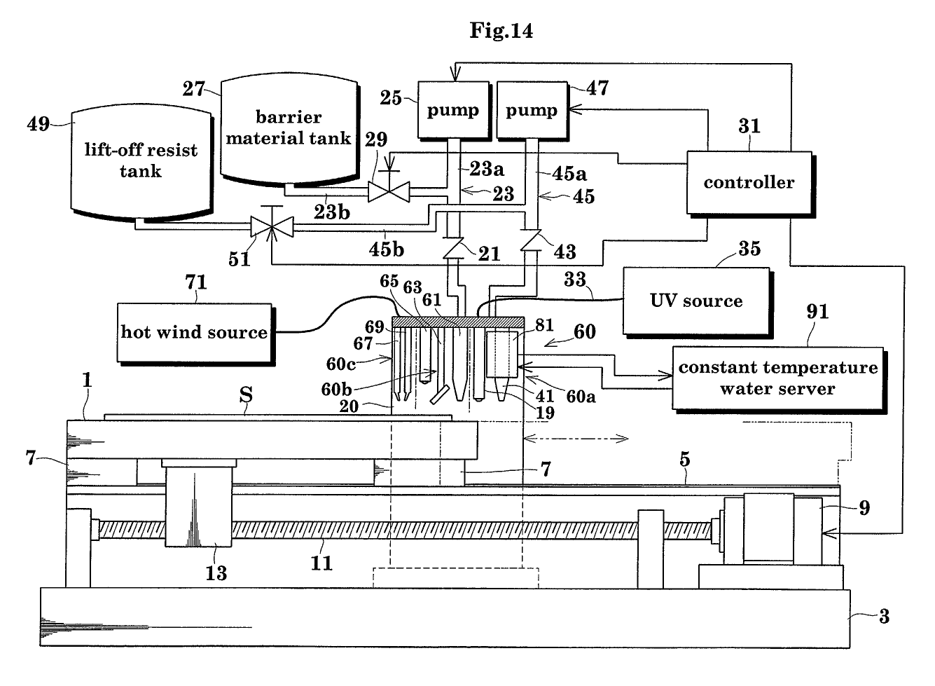

(3) The third embodiment described above corresponds to the first embodiment combined with the delivery from the nozzle 17 of the rib material maintained at the constant temperature. As shown in FIG. 14, the second embodiment may be combined with the delivery from the nozzle 41 of the lift-off resist maintained at the constant temperature. Then, relief patterns may be formed with a high aspect ratio and steady shape.

(4) In the first to third embodiments, the nozzle 17 or 41 is placed in vertical posture relative to the back plate S for delivering the rib material or lift-off resist to the back plate S. As shown in FIG. 13, the nozzle 17 or 41 may be tilted relative to the back plate S in the direction of relative movement, for delivering the rib material or lift-off resist to the back plate S. The nozzle 17 or 41 may be set to a desired tilt angle 0 which, preferably, is in a range of 45 to 60 degrees, for example.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method of forming barrier ribs on a back plate for use in a flat panel display, said method comprising:
a rib material delivery step for delivering a rib material from nozzle means while moving said nozzle means and said back plate relative to each other; and
a rib material curing step for curing said rib material on said back plate while delivering said rib material from said nozzle means.

2. A method of forming barrier ribs for a flat panel display as defined in claim 1, wherein said rib material curing step is executed for curing said rib material by irradiating said rib material with light or heat, or supplying a hot blast thereto.

3. A method of forming barrier ribs for a flat panel display as defined in claim 1, wherein said rib material curing step is executed for curing said rib material immediately after said rib material is delivered from said nozzle means to said back plate.

4. A method of forming barrier ribs for a flat panel display as defined in claim 2, wherein said rib material curing step is executed for curing said rib material immediately after said rib material is delivered from said nozzle means to said back plate.

5. A method of forming barrier ribs for a flat panel display as defined in claim 1, wherein said rib material delivery step is executed for delivering said rib material simultaneously from a plurality of discharge openings formed in said nozzle means.

6. A method of forming barrier ribs for a flat panel display as defined in claim 5, wherein said rib material delivery step is executed for delivering said rib material from said nozzle means having a plurality of nozzles arranged in a direction perpendicular to a direction of relative movement, with ends of said nozzles partly overlapping each other.

7. A method of forming barrier ribs for a flat panel display as defined in claim 1, wherein said rib material delivery step includes a rib material constant temperature delivery step for delivering said rib material from said nozzle means while moving said nozzle means and said back plate relative to each other, and while maintaining said rib material at a constant temperature.

8. A method of forming barrier ribs for a flat panel display as defined in claim 7, wherein said rib material constant temperature delivery step is executed for delivering said rib material from said nozzle means, said rib material supplied being maintained at said constant temperature in or adjacent said nozzle means.

9. A method of forming barrier ribs for a flat panel display as defined in claim 7, wherein said rib material constant temperature delivery step is executed for delivering said rib material from said nozzle means, said rib material supplied being maintained at said constant temperature in or adjacent said nozzle, lower than a temperature upstream thereof.

10. A method of forming barrier ribs for a flat panel display as defined in claim 1, wherein said nozzle means defines discharge openings shaped longer in a direction of relative movement between said nozzle means and said back plate than in a direction perpendicular to said direction of relative movement.

11. A method of forming barrier ribs on a back plate for use in a flat panel display, said method comprising:
a lift-off resist delivery step for delivering a lift-off resist from nozzle means to form relief patterns while moving said nozzle means and said back plate relative to each other;
a filling step for filling a rib material into spaces between said relief patterns;
a rib material curing step for curing said rib material; and
a removal step for removing said relief patterns;
the above steps being successively executed to form barrier ribs.

12. A method of forming barrier ribs for a flat panel display as defined in claim 11, further comprising a lift-off resist curing step for curing said lift-off resist on said back plate while delivering said lift-off resist from said nozzle means.

13. A method of forming barrier ribs for a flat panel display as defined in claim 12, wherein said lift-off resist curing step is executed for curing said lift-off resist by irradiating said lift-off resist with light or heat, or supplying a hot blast thereto.

14. A method of forming barrier ribs for a flat panel display as defined in claim 12, wherein said lift-off resist curing step is executed for curing said lift-off resist immediately after said lift-off resist is delivered from said nozzle means to said back plate.

15. A method of forming barrier ribs for a flat panel display as defined in claim 13, wherein said lift-off resist curing step is executed for curing said lift-off resist immediately after said lift-off resist is delivered from said nozzle means to said back plate.

16. A method of forming barrier ribs for a flat panel display as defined in claim 11, wherein said lift-off resist delivery step is executed for delivering said lift-off resist simultaneously from a plurality of discharge openings formed in said nozzle means.

17. A method of forming barrier ribs for a flat panel display as defined in claim 16, wherein said lift-off resist delivery step is executed for delivering said lift-off resist from said nozzle means having a plurality of nozzles arranged in a direction perpendicular to a direction of relative movement, with ends of said nozzles partly overlapping each other.

18. A method of forming barrier ribs for a flat panel display as defined in claim 11, wherein said lift-off resist delivery step includes a lift-off resist constant temperature delivery step for delivering said lift-off resist from said nozzle means while moving said nozzle means and said back plate relative to each other, and while maintaining said lift-off resist at a constant temperature.

19. A method of forming barrier ribs for a flat panel display as defined in claim 11, wherein said nozzle means defines discharge openings shaped longer in a direction of relative movement between said nozzle means and said back plate than in a direction perpendicular to said direction of relative movement.

20. An apparatus for forming barrier ribs on a back plate for use in a flat panel display, said apparatus comprising:
nozzle means for delivering a rib material;
a support table for supporting said back plate;
moving means for moving said nozzle means and said support table relative to each other; and
curing means for curing said rib material delivered to said back plate;
wherein said rib material is delivered from said nozzle means while said moving means is operated to move said nozzle means and said back plate relative to each other, and said rib material on said back plate is cured by said curing means while said rib material is delivered from said nozzle means.

21. An apparatus for forming barrier ribs for a flat panel display as defined in claim 20, wherein said curing means is arranged to cure said rib material by irradiating said rib material with light or heat, or supplying a hot blast thereto.

22. An apparatus for forming barrier ribs for a flat panel display as defined in claim 20, wherein said curing means is disposed adjacent said nozzle means to cure said rib material immediately after said rib material is delivered from said nozzle means to said back plate.

23. An apparatus for forming barrier ribs for a flat panel display as defined in claim 21, wherein said curing means is disposed adjacent said nozzle means to cure said rib material immediately after said rib material is delivered from said nozzle means to said back plate.

24. An apparatus for forming barrier ribs for a flat panel display as defined in claim 20, wherein said nozzle means has a plurality of discharge openings for simultaneously delivering said rib material.

25. An apparatus for forming barrier ribs for a flat panel display as defined in claim 24, wherein said nozzle means has a plurality of nozzles arranged in a direction perpendicular to a direction of relative movement, with ends of said nozzles partly overlapping each other.

26. An apparatus for forming barrier ribs for a flat panel display as defined in claim 20, further comprising thermostat means for maintaining said rib material at a constant temperature, wherein said rib material is delivered from said nozzle means while moving said nozzle means and said back plate relative to each other, and while maintaining said rib material at said constant temperature.

27. An apparatus for forming barrier ribs for a flat panel display as defined in claim 26, wherein said thermostat means is disposed adjacent said nozzle means to maintain said rib material at said constant temperature for delivery from said nozzle means.

28. An apparatus for forming barrier ribs for a flat panel display as defined in claim 26, wherein said thermostat means maintains said rib material at said constant temperature in or adjacent said nozzle means, lower than a temperature upstream thereof, for delivery from said nozzle means.

29. An apparatus for forming barrier ribs for a flat panel display as defined in claim 20, wherein said nozzle means defines discharge openings shaped longer in a direction of relative movement between said nozzle means and said back plate than in a direction perpendicular to said direction of relative movement.

30. An apparatus for forming barrier ribs on a back plate for use in a flat panel display, said apparatus comprising:
nozzle means for delivering a lift-off resist to form rib-forming relief patterns;
a support table for supporting said back plate;
moving means for moving said nozzle means and said support table relative to each other;
filling means for filling a rib material into spaces between said relief patterns; and
removing means for removing said relief patterns;
wherein said lift-off resist is delivered from said nozzle means while said moving means is operated to move said nozzle means and said back plate relative to each other.

31. An apparatus for forming barrier ribs for a flat panel display as defined in claim 30, further comprising curing means for curing said lift-off resist delivered to said back plate, wherein said lift-off resist is delivered from said nozzle means while said moving means is operated to move said nozzle means and said back plate relative to each other, and said lift-off resist on said back plate is cured by said curing means while said lift-off resist is delivered from said nozzle means.

32. An apparatus for forming barrier ribs for a flat panel display as defined in claim 31, wherein said curing means is arranged to cure said lift-off resist by irradiating said lift-off resist with light or heat, or supplying a hot blast thereto.

33. An apparatus for forming barrier ribs for a flat panel display as defined in claim 31, wherein said curing means is dispose adjacent said nozzle means to cure said lift-off resist immediately after said lift-off resist is delivered from said nozzle means to said back plate.

34. An apparatus for forming barrier ribs for a flat panel display as defined in claim 32, wherein said curing means is dispose adjacent said nozzle means to cure said lift-off resist immediately after said lift-off resist is delivered from said nozzle means to said back plate.

35. An apparatus for forming barrier ribs for a flat panel display as defined in claim 30, wherein said nozzle means has a plurality of discharge openings for simultaneously delivering said lift-off resist.

36. An apparatus for forming barrier ribs for a flat panel display as defined in claim 35, wherein said nozzle means has a plurality of nozzles arranged in a direction perpendicular to a direction of relative movement, with ends of said nozzles partly overlapping each other.

37. An apparatus for forming barrier ribs for a flat panel display as defined in claim 30, further comprising thermostat means for maintaining said lift-off resist at a constant temperature for delivery from said nozzle means, wherein said lift-off resist maintained at said constant temperature is delivered from said nozzle means while said moving means is operated to move said nozzle means and said back plate relative to each other, and said lift-off resist on said back plate is cured by said curing means while said lift-off resist is delivered from said nozzle means.

38. An apparatus for forming barrier ribs for a flat panel display as defined in claim 30, wherein said nozzle means defines discharge openings shaped longer in a direction of relative movement between said nozzle means and said back plate than in a direction perpendicular to said direction of relative movement.
